(19) United States
(12) Patent Application Publication
(10) Pub. No.: US 2010/0223338 A1
(43) Pub. Date: Sep. 2, 2010

(54) METHOD AND SYSTEM FOR PROCESSING MESSAGES

(76) Inventor: Alan Maurice Hodes, London (GB)

Correspondence Address: BAINWOOD HUANG & ASSOCIATES LLC, 2 CONNECTOR ROAD, WESTBOROUGH, MA, 01581, US

(21) Appl. No.: 11/994,175

(22) PCT Filed: Jul. 3, 2006
(86) PCT No.: PCT/EP06/63821

§ 371 Date: Jan. 7, 2008

(30) Foreign Application Priority Data
Jul. 1, 2005 (GB) 01513310.3

(51) Int. Cl. G06F 15/16

(52) U.S. Cl. 709/206

(57) ABSTRACT

A sender creates a multi-part message having a recipient field including identifiers of recipients of the message and an identifier of the sender. The multi-part message comprises a main message having a content A. Further, the multi-part message comprises an auxiliary message, having a recipient field including identifiers of recipients of the auxiliary message, and a content B. The message is split into two messages: a main message having a header and a content A; and a first auxiliary message having a header and a content B. Association data for associating the main message to the first auxiliary message is created. The first and second messages are transmitted together with the association data. The messages are received and are dynamically re-combined according to the recipients. Recipient 1 is only privy to message content A. Therefore, a message received by recipient 1 corresponds to the main message. Recipient 2 is privy to message content A and message content B. Therefore the main message having content A is combined with the first auxiliary message, having content B, using the association data, to form a message received by recipient 2. Thus, recipient 2 can view both content A and content B.

### FIELD OF THE INVENTION

The present invention relates to a method and system for processing electronic messages. In particular, the present invention relates to processing received electronic messages and creating electronic messages.

The invention is further concerned with new functionality for software adapted for use in sending and receiving electronic messages, such as electronic mail (referred to herein as e-mail) messages. More specifically, but not exclusively, this invention is concerned with the discrete dissemination of particular information related to, attached or enclosed with e-mail items.

### BACKGROUND OF THE INVENTION

A known messaging system in which messages having recipient-specific content is described in U.S. Pat. No. 6,192,396. In this system, shown in FIG. 11, a sender composes an e-mail message 1000, having a content of unrestricted text 1002 which is intended for all recipients to read, and a content of restricted text 1004 which is intended to be restricted to one or more recipients. The restricted text is shown amongst the unrestricted text, and may be underlined, or indicated in some other way to distinguish it from the unrestricted text (this increases in complexity as more text is selected to go to different recipients, and this may be confusing for the sender). The sender may select and view the text to be sent to the different recipients by means of drop down boxes, for example.

It is necessary for the system to send the e-mail in such a way that the recipients not party to the restricted text 1004 do not receive this text, but so that the recipients for which the restricted text 1004 is intended can view this text. Obviously, it is necessary for the recipients not privy to the restricted text to be unaware of the fact that such restricted text exists. Otherwise they may attempt to discover the information to which this text relates.

FIG. 11 shows an e-mail 1000 having a content A, which is intended for recipient 1 and recipient 2, and having a content B, which is intended for recipient 2 only. The e-mail 1000 has a recipient field 1006, showing the identifiers (such as e-mail addresses of the recipients 1 and 2). The fact that B represents restricted content 1004 is denoted by underlining B. As shown in FIG. 11, the system splits the e-mail into two different e-mails. A first e-mail 1010 has a recipient field 1012, showing the network identifier of recipient 1, and has only the content A. A second e-mail 1020 has a recipient field 1022 having the network identifier of recipient 2, and has content A and B.

Recipient 2 can see from the received e-mail that content B is restricted, since this is indicated in the text, as shown in FIG. 11. For clarity, FIG. 11 only shows an e-mail having one portion of restricted content 1004, which can be viewed by one of the recipients. However, in this system a number of different portions of text can be assigned for viewing by a number of different people. In the case where there are more than two recipients, each being privy to a different combination of restricted and non-restricted text, a number of different e-mails, corresponding to the number of different combinations of text which are produced.

However, there is a serious drawback to this method: as can be seen from FIG. 11, the integrity of the recipient field 1006 of the original e-mail 1000 is compromised when the e-mail is split up. This is necessary, because if recipient 1 remained in the recipient field 1022 of the e-mail destined for recipient 2, recipient 1 would receive the message. In this case recipient 1 would be able to review the restricted content B, which is obviously undesirable.

Further, the fact that the integrity of the recipient field 1006 of the original e-mail 1000 is compromised means that recipients 1 and 2 cannot see who else received the e-mail (apart from those recipients, if any, who are privy to the same combination of text as themselves). This has implications if a recipient wishes to reply to the e-mail, since they can only reply to the sender, and any other recipients privy to the same combination of text as themselves.

Further, an example of a team leader sending an e-mail to a team will now be considered. In such an example, each member of the team would expect an e-mail from the team leader to be sent to each member of the team. If the team leader sends an e-mail with some restricted text, which is only intended for a first half of the team, for example, the recipient field of an e-mail received by a second half of the team will only contain the e-mail addresses of that half. In this way it is likely to be apparent to the second half of the team that there was some information that they were not sent.

US 2004/0019644 relates to a similar system, in which selected portions of text in an e-mail can be restricted to certain recipients. The system disclosed in this document encrypts the restricted content, so that the e-mail can be sent to all recipients, but that the restricted text can be decrypted only by the required recipients. A further arrangement of the system provides a box, into which a password can be entered, in order to retrieve restricted information.

However, this prior art suffers from the drawback that the restricted information is always present in the e-mail received by the recipients not privy to the information. It is likely that they will be able to see something which indicates the presence of some restricted information (particularly in the case where the password box is provided), or if the encrypted text is shown as “junk”, for example if a recipient not party to the restricted information is using incompatible software to view the e-mail.

Therefore, there are disadvantages associated with the prior art which compromise the secrecy of such e-mails and of the data contained therein. Further, prior art such as that shown in FIG. 11 has the disadvantage that the functionality of replying to an e-mail is severely compromised.

It is an object of the present invention to address these disadvantages.

### SUMMARY OF THE INVENTION

According to a first aspect of the present invention, there is provided a method of processing received messages, said messages originating from a sender and being destined for at least one recipient, the method comprising the steps of:

receiving a first message, said first message comprising data indicative of a first set of recipients for said first message, said first set of recipients comprising at least one first recipient;

receiving a second message, said second message comprising data indicative of a second set of recipients for said second message, said second set comprising at least one second recipient, wherein said first set of recipients comprises at least one recipient not contained in said second set of recipients;

processing data indicative of an association between said first message and said second message; and

preparing said second message for display in association with said first message, on the basis of said data indicative of an association between said first message and said second message.

Thus, the invention in the first aspect gives a system in which restricted information can be conveyed in a message to one or more recipients, in such a way that recipients not privy to the information cannot determine that such information exists, and in such a way that the integrity of the header is not compromised.

The method may further comprise the steps of:

receiving a third message comprising a third content, said third message comprising data indicative of a third set of recipients for said third message, said third set of recipients comprising at least one third recipient, wherein said third set of recipients comprises at least one recipient not contained in said first set of recipients;

processing data indicative of an association between said first message and said third message; and

preparing said third message for display in association with said first message, on the basis of said data indicative of an association between said first message and said third message.

Thus, the functionality of the invention may provide for multiple portions of restricted message content, associated with the first, second and third messages.

The first message may comprise a first content, and said second message may comprise a second content.

The first message may not comprise said second content.

The second message may not comprise said first content.

Thus, the second message may contain restricted information to which only recipients of the second message are privy.

The method may further comprise the steps of:

receiving response data indicative of a response message content from a recipient in said second set, said response message content comprising a fourth content and a fifth content, said response data comprising data indicative of a fourth set of recipients for said fourth content, said fourth set comprising at least one fourth recipient for said fourth content;

creating a fourth message, to said fourth set of recipients, said fourth message comprising said fourth content, said fourth message not comprising said fifth content;

accessing data indicative of a fifth set of recipients for said fifth content, said fifth set of recipients comprising at least one fifth recipient, wherein said fourth set of recipients comprises at least one recipient not contained in said fifth set of recipients;

creating a fifth message, to said fifth set of recipients, said fifth message comprising said fifth content, said fifth message not comprising said fourth content;

creating association data, said association data associating said fourth message with said fifth message.

Thus, in this way, known replying functionality can be maintained.

The first and second message further may data indicative of a sender of said first and second message, and wherein said fourth set of recipients and said fifth set of recipients may each comprise data indicative of said sender of said first and second message.

The fourth message content may comprise said first message content.

The fifth message content may comprise said second message content.

According to a second aspect of the present invention there is provided a method of creating a message from a sender, said message being destined for at least one recipient, the method comprising the steps of:

accessing data indicative of a multi-part message content, said multi-part message content comprising a first content and a second content;

accessing data indicative of a first set of recipients for said first content, said first set of recipients comprising at least one first recipient for said first content;

creating a first message, to said first set of recipients, said first message comprising said first content, said first message not comprising said second content;

accessing data indicative of a second set of recipients for said second content, said second set of recipients comprising at least one second recipient, wherein said first set of recipients comprises at least one recipient not contained in said second set of recipients;

creating a second message, to said second set of recipients, said second message comprising said second content, said second message not comprising said first content;

creating association data, said association data associating said first message with said second message.

Accordingly, a message having restricted content not intended for one or more of the recipients can be created, whilst main the secrecy of the restricted content, and the header integrity.

The multi-part message content further may comprise a third content, said first content not comprising said third content, and wherein said method further comprises the steps of:

accessing data indicative of a third set of recipients for said third content, said third set of recipients comprising at least one third recipient for said third content;

creating a third message, to said third set of recipients, said third message comprising said third content, said third message not comprising said first content;

creating association data, said association data associating said first message with said third message.

Thus, a message with multiple portions of restricted content can be provided.

The at least one first recipient and said at least one second recipient may both comprise at least one common recipient having the same identifier.

In this way, restricted text can be sent to the common recipient.

The association data may be adapted for associating said first message with said second message only for said common recipients.

This means that the first and second messages are only combined for the common recipients, so that recipients other than the common recipients are not provided with restricted content.

The association data may comprise a first portion of association data, and a second portion of association data, and wherein said first message may comprise said first portion of association data, and said second message comprises said second portion of association data.

Thus, the association data can be included in the first and/or second message.

The first portion of association data comprises a first portion of an encryption key, and wherein said second portion of association data comprises a second portion of an encryption key.

This means that the message can be encrypted, having two portions of an encryption key. Therefore messages can only be viewed by a recipient privy to both portions of the key.

One of said first portion of association data and said second portion of association data may comprise an identifier of the or each common recipient.

This means that the identifier of the or each common recipient can be used as part of the decryption process, so that a message can only be decrypted for the or each common recipient.

The first message may have a header, and wherein said header comprises at least part of said association data.

The second message may have a header, and wherein said header comprises at least part of said association data.

The association data may comprise a tag in at least one of said first message or said second message.

The association data may comprise an association message.

This means that the association data can be sent separately from the first and second messages.

The first message and said second message may each comprise an e-mail message.

According to a third aspect of the present invention there is provided data signals comprising a set of associated messages, comprising at least a first message destined for a first set of recipients comprising at least one first recipient and a second message destined for a second set of recipients comprising at least one second recipient, wherein said first set of recipients comprises at least one recipient not contained in said second set of recipients, wherein said first message comprises a first content, not present in said second message, and said second message comprises a second content not present in said first message, and wherein said set of linked messages further comprises association data, for associating said first message with said second message.

The at least one first recipient and said at least one second recipient may both comprise at least one common recipient having the same identifier; and wherein said association data is adapted for associating said first message with said second message only for said common recipients.

According to a fourth aspect of the present invention there is provided computer software for processing received messages, said messages originating from a sender and being destined for at least one recipient, comprising a receiving function for:

receiving a first message, said first message comprising data indicative of an identifier of at least one first recipient for said first message;

receiving a second message, said second message comprising data indicative of an identifier of at least one second recipient for said second message;

processing data indicative of an association between said first message and said second message;

wherein said computer software also comprises an associating function for associating said first message with said second message, on the basis of said data indicative of an association between said first message and said second message.

According to embodiments the present invention therefore there is provided a software upgrade or add-on to an e-mail application, be it web-based or a dedicated PC client application, adapted for the sending and/or receiving of e-mail messages to multiple recipients, said e-mail application including a message compilation interface including a number of standard fields to which a user can add said multiple recipients, a subject heading, message content (including body text and/or other content such as one or more attachments), characterised in that said interface further comprises one or more additional auxiliary message fields of a “auxiliary message” into which may be entered additional auxiliary message content (including auxiliary message body text and/or other content such as one or more attachments), together with one or more auxiliary message recipient fields, said software enhancement being provided with said message compilation interface to enable the information provided in the additional auxiliary message field to be revealed only to one or more recipients entered in the auxiliary message recipient fields but nevertheless permitting those recipients entered in the standard recipient fields to see information other than that entered in the additional auxiliary message fields and additional auxiliary message recipient fields. An auxiliary message is a message, which is appended to or otherwise associated with another message, such as an e-mail.

In one embodiment, the software enhancement causes the e-mail client application to send the information provided in the auxiliary message fields separately from the e-mail itself. In this embodiment there is thus a main e-mail and an auxiliary e-mail containing information in the one or more auxiliary message fields, said auxiliary e-mail being sent only to the recipients identified in the auxiliary message recipient field, said auxiliary message field information being optionally encrypted, and furthermore being interpreted and revealed to said auxiliary message information recipients on conditions that they have 1) the corresponding main e-mail message existing in their e-mail “inbox” 2) a licensed version of the software enhancement installed on the computer, and 3) successfully verified that they are the intended recipient of said auxiliary message information. These requisites intrinsically link the main e-mail with the auxiliary e-mail and thus the auxiliary message information.

Preferably each of the main and auxiliary e-mails are coded or tagged on the “send” action so that they can be successfully married on receipt.

In a first version of the software enhancement, the message compilation interface includes the embedded auxiliary message fields and auxiliary message recipient fields into which relevant information can be entered.

In a second version of said software enhancement, the auxiliary message information and auxiliary message enhancement fields are caused to float in front of optionally modally, the standard message compilation interface of the host e-mail client or webmail application, said floating field being intrinsically linked to and operative with the message compilation interface by means of the software enhancement.

In a 3rd version, the software enhancement generates an altogether new messaging interface which interrupts, suppresses and usurps the standard interface of said e-mail client, displaying the new auxiliary message fields and associated functionality as part of the new interface said new interface being intrinsically linked to and operative with said e-mail client by means of the software enhancement.

Most preferably, the recipients in the additional auxiliary message recipient field form a subset of those recipients in the standard recipient fields of the message compilation interface.

Preferably the software enhancement is in the form of an add-on application which is distinct and separate from the e-mail client application.

Alternately, the software enhancement is in the form of an add-in application which is installed within or forms part of the e-mail client application so as to control the operation thereof.

In certain permutations of e-mail client/webmail and operating system, the software enhancement may be both an add-on as well as an add-in.

In the case of web-mail, the interface, in the instance where the additional auxiliary message fields are embedded in it as in the first version (above), will be developed with the web-mail service provider on an individual basis so as to maintain a preferred “look and feel” subject to the requirements of each service provider. Meanwhile, the underlying architecture i.e. encryption protocols, “tagging” and reconstituting system used to successfully marry the auxiliary message field information with the main e-mail on receipt will remain unchanged, thus allowing web-mail e-mail messages to be read successfully by client-based accounts and vice-versa. Intended targets for web-mail services include (but not limited to): MS Outlook Web Access, Lotus Domino Web Access, Lotus Workplace Web Access, Novell GroupWise Web Access, AOL, Earthlink, Yahoo! Mail, MSN Hotmail, Google G-Mail and Sina (all registered trade marks).

Preferably the e-mail client application can be any of Lotus notes, Novell GroupWise, Microsoft Outlook or Outlook Express, Pegasus Mail, Eudora Mail, or indeed any of the commercially or freely available e-mail clients currently in use on Windows, Linux, Unix or Apple Macintosh (all registered trade marks) operating systems.

Where the software enhancement is an add-in, the operating system on which the e-mail client application runs may be Microsoft Windows, and the e-mail client application may be Microsoft Outlook, the add-in may be in the form of a Component Object Model (COM) add-in.

Alternatively, the software enhancement may be an add-on when the interface supports a floating graphical user interface (GUI).

Preferably, the message compilation interface includes multiple additional auxiliary message fields, multiple auxiliary message attachment fields and multiple auxiliary message recipient fields each of which are linked to the corresponding additional auxiliary message fields, said software enhancement providing a facility where multiple additional pieces of encrypted information can be sent to all the various standard recipients of an e-mail message, but only recipients in each of a plurality of subsets of all the standard recipients entered can decrypt the additional pieces of encrypted information which the sender intends for those recipients.

Preferably the software enhancement can interact with any standard e-mail messaging protocol, including but not limited to Internet Message Access Protocol (IMAP), Post Office Protocol (POP), Simple Message Transfer Protocol (SMTP).

Those skilled in the art of e-mail messaging, and software enhancements therefor will be apprised of the manner in which the software enhancement might be delivered in terms of the particular programming language which might be used, and for example the software enhancement may be programmed in Visual Basic, Delphi, C, C++, C#, or other programming language.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a message compilation interface modified according to embodiments of the invention;

FIG. 2 shows the message compilation interface of FIG. 1 with data entered into the fields and a context-sensitive menu list allowing a user to add auxiliary message information to one of a plurality of possible additional auxiliary message fields;

FIG. 3 shows the message compilation interface of FIG. 5 with a further context-sensitive menu list allowing a user to select which of the one or more additional auxiliary message fields should be capable of being decrypted by which of the auxiliary message recipients entered in the auxiliary message recipient field;

FIG. 4 shows an alternative message compilation interface;

FIG. 5 shows a message interface of a received message;

FIG. 6 is a schematic diagram showing a system for implementing embodiments of the present invention;

FIG. 7 is a schematic diagram showing the operation of a first embodiment of the present invention;

FIGS. 8a and 8b are schematic diagrams showing the operation of a first embodiment of the present invention;

FIG. 9 is a schematic diagram showing the operation of a reply function of the first embodiment of the present invention;

FIG. 10 is a schematic diagram showing the operation of a second embodiment of the present invention; and

FIG. 11 is a schematic diagram showing the operation of a prior-art system.

### DETAILED DESCRIPTION OF THE INVENTION

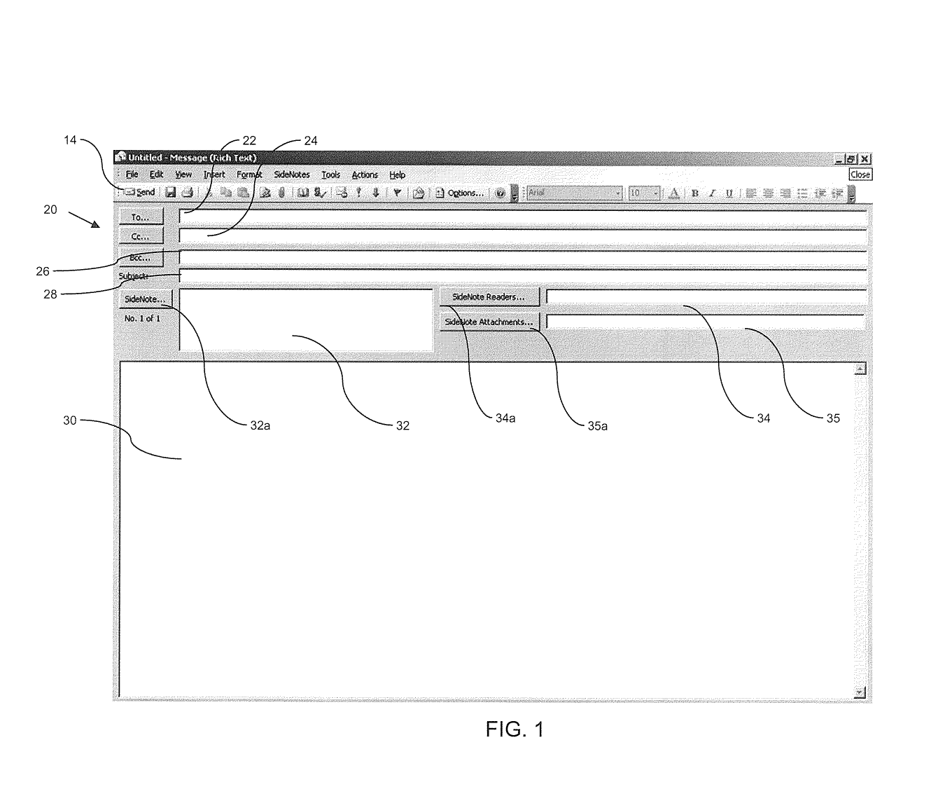

Referring to FIG. 1, there is shown an e-mail message compilation interface 20. In this example the e-mail message compilation interface is a modified version of a known interface, which can be produced, for example using add-on software. The e-mail interface includes standard recipient, subject and message body fields 22, 24, 26, 28, 30 respectively. Further, the e-mail message has a “auxiliary message” associated therewith. An auxiliary message is a message, which is appended to or otherwise associated with another message (referred to herein as a “main message”), such as an e-mail. The modified interface additionally includes an auxiliary message interface part which includes an auxiliary message body field 32 (for auxiliary message text and/or other message content), an auxiliary message recipient field 34 and an auxiliary message attachment field 35. As is conventional in modifying or customizing standard interface forms such as that shown at 20, each of the additional fields 32, 34, 35 has an associated user selectable command button 32a, 34a, 35a each of which has one or more particular functions associated therewith as described below. The term “content” used herein in relation to a message and/or an auxiliary message shall be taken to include any content of the message body, such as text and/or images, and shall further be taken to include attachments to that message or auxiliary message. The term “content” when applied to a main message does not include an associated auxiliary message.

Once an e-mail message has been compiled using this interface by entering at least one recipient address in one of the fields 22, 24, and usually by completing the subject field 28, and entering some text, for example in the message body field 30, a “Send” button 14 provided on the interface 20 may be clicked by a user to deliver the message by one of any of a number of messaging protocols, some of which have been mentioned above.

There are various other functions provided by the various other buttons and menu items provided on the interface 20, e.g. which cause the message appearance to be altered, or which allow for standard boilerplate text to be inserted, to name but a few, but, as these functions are not proposed to be altered by the present invention, they are not further discussed here.

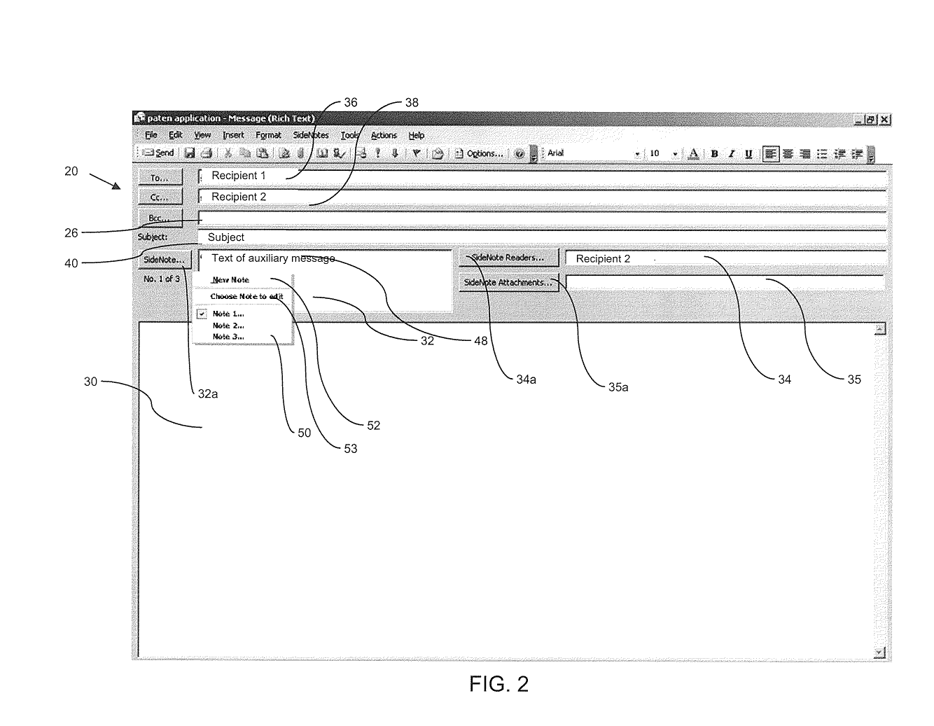

As can be seen in FIG. 2, the modified interface 20 has been further provided with the standard type of information which might be entered in a standard message compilation interface. In the “To” field 22 a user has entered a standard e-mail address 36, in the “Cc” field 24, the user has entered a further different standard e-mail address 38 to whom a carbon copy of this message is to be sent, and subject or heading information has been entered as shown at 40.

It is also to be noted from this Figure that an auxiliary message content, which comprises auxiliary message text 48, in this example, has been added to the auxiliary message body field 32, and it is this auxiliary message text 48, along with any attachment(s) entered in field 35 which are intended to be sent. The auxiliary message will not normally be received by recipients not in the auxiliary message recipient field 34. In the case where such a recipient does receive data relating to the auxiliary message the auxiliary message will not be deciphered.

An identifier of an auxiliary message recipient can be added directly to the auxiliary message recipient field 34, or can be added via standard recipient fields 22, 24, 26. For example, the software can cause a pop-up window to appear (for example if the user “right clicks” or puts the mouse pointer over one of the recipients listed in the standard recipient field), giving a user the option of adding a recipient in one of these fields to the auxiliary message recipient field 34. If there are multiple auxiliary messages, in accordance with many known software applications, the “active” auxiliary message i.e. the auxiliary message which has the focus, or has otherwise been selected is the one that will respond to the selected function, or appropriate user input.

The software according to embodiments of the present invention may populate a recipient field such as the “BCC” field of the main e-mail 20 with the identifier of a recipient in the auxiliary message recipient field 34, if this identifier is not already present in either the “To”, “CC” or “BCC” fields of the main e-mail.

FIG. 2 further shows additional functionality provided by the button 32a associated with the auxiliary message body field 32 in which the information intended by the sender to be viewed only by the reduced subset of all the recipients entered in the standard recipient fields 22, 24, 26 is intended to be seen. At this stage it is also to be mentioned that the button 34a associated with auxiliary message recipient field 34 can be clicked by a user and acts in much the same way as any of the buttons associated with the standard recipient fields 22, 24, 26 respectively in that these buttons generally provide access to an e-mail address book or list of contacts from which a plurality of e-mail addresses may be chosen.

As shown in FIG. 2, the clicking of button 32a results in the display of a further context sensitive menu 50 on which it is possible to display one of a plurality of different auxiliary message fields by selecting the “New Note” menu item 52. In this embodiment, the user can create and send a virtually unlimited quantity of different auxiliary messages to an equal quantity of different subsets of recipients of the total number of recipients identified in the standard recipient fields 22, 24, 26. Additionally within the context-sensitive menu 50 there is provided the means of independently selecting particular auxiliary messages, and a further option to “Choose note to edit” is shown at 53. Obviously, a lesser or greater number of auxiliary message fields may be provided.

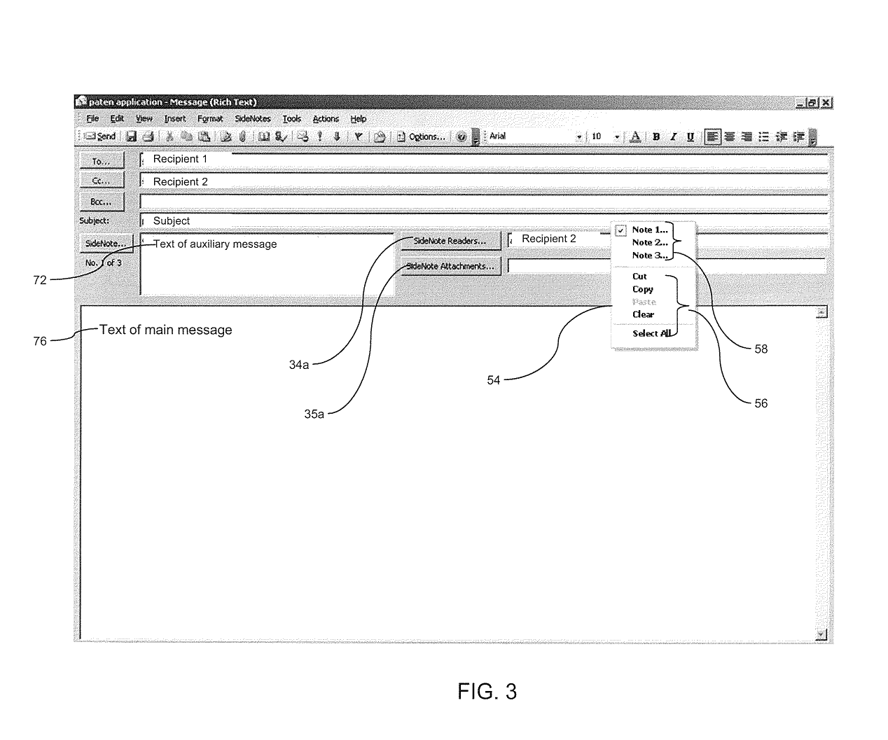

Turning now to FIG. 3 there is shown a yet further context-sensitive menu 54 which may be activated by right-clicking on any one of the e-mail addresses of the auxiliary message recipients in auxiliary message recipient field 34, which, again, has a number of standard menu functions identified at 56. This context-sensitive menu 54 shows a list of the completed auxiliary message fields 58 which are intended by the sender of the message to be seen by any of the recipients whose e-mail address has been entered in the auxiliary message recipient field 34. The e-mail address, or other identifier of the recipient may be selected, so that the list of auxiliary messages intended for that recipient can be displayed. For example, the context sensitive menu 54 may be caused to appear by the user performing a right click operation on a standard mouse when the mouse pointer on screen is positioned above one of the recipients e-mail address entered in the auxiliary message recipient field 34. FIG. 3 shows some text 72 in the auxiliary message body field 32, and some text 76 in the message body field 30.

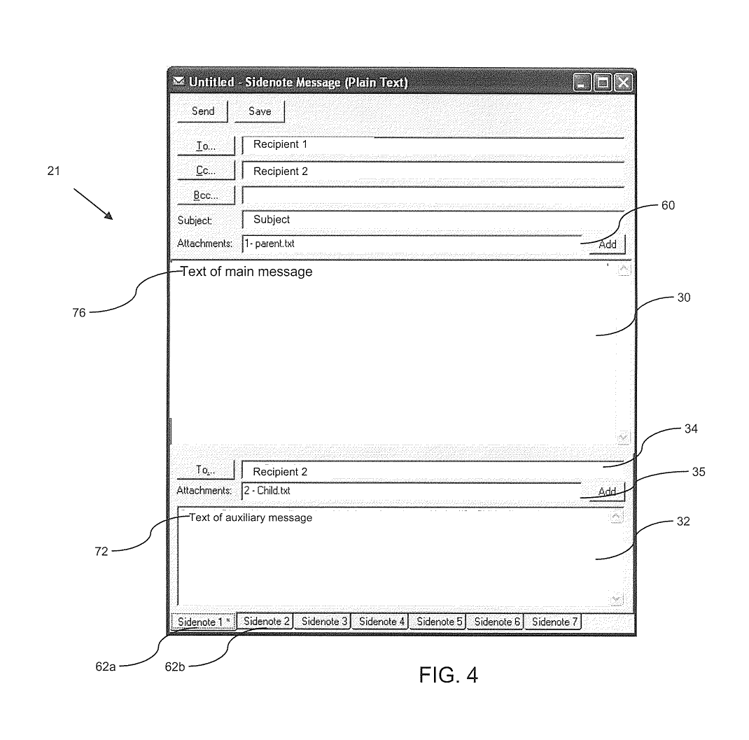

FIG. 4 shows a representation of an alternative user interface for creating an e-mail 21 with an associated auxiliary message, having an auxiliary message body field 32 for entering text 72 to be sent to a recipient having an identifier in an auxiliary message “To” field 34. A discussion of the fields common to those discussed above will be omitted.

In this example, the e-mail 21 destined to all recipients has an attachment “1-Parent.txt” in a main e-mail attachment field 60, and text 76 in the message body field 30. The text of a first auxiliary message has been entered in the auxiliary message body field 32. The recipient having an e-mail address “Recipient 2” is the only recipient who will be able to view the text of the auxiliary message. In addition, this recipient is the only recipient who will be able to view the attachment “2-Child.txt”, which has been entered in the auxiliary message attachment field 35. The recipient having the identifier “Recipient 1” will not be able to see the auxiliary message text entered in the auxiliary message body field 32, and will only receive text in the message body field 30 of the e-mail 21, together with the common attachment.

As can be seen from this Figure, the different auxiliary messages, (i.e. the content entered in the auxiliary message body field 32, and the attachments associated therewith can be viewed by clicking associated tabs 62a, 62b).

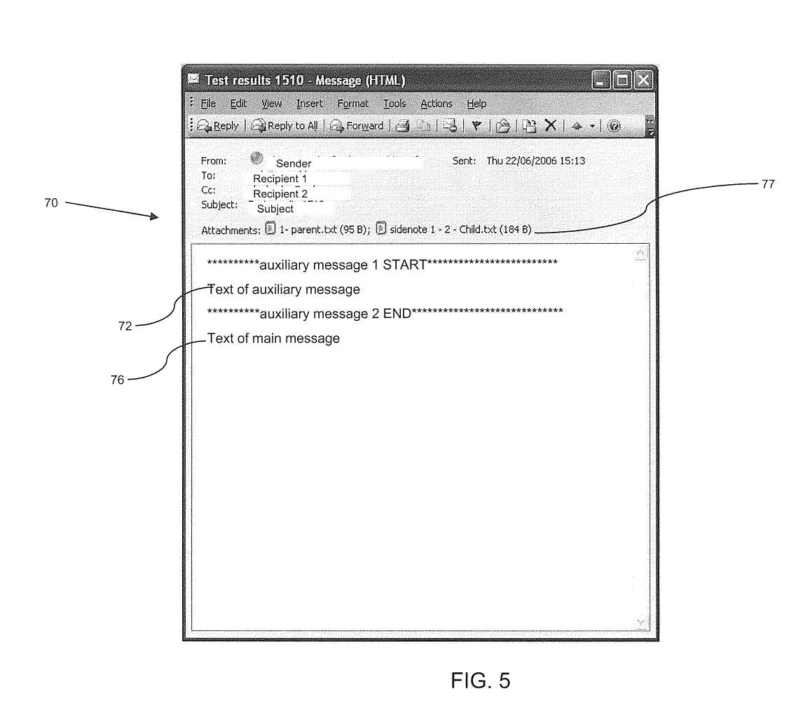

FIG. 5 shows a representation of a received e-mail 70 which shows how the e-mail 21 in FIG. 4 looks when it is received by the auxiliary message recipient “Recipient 2”. As can be seen from this Figure, the text from the auxiliary message body field 32 of FIG. 4 is shown as in-line text 72 in the e-mail. Further, the attachment to the auxiliary message as seen in field 35 of FIG. 4 which can only be viewed by the recipient having the identifier “Recipient 2” is located in the attachment field 77 of the main e-mail and is identified by the prefix “auxiliary message 1” so that Recipient 2 understands that this attachment will not be seen by all other recipients.

The text 76 from the message body field 30 of FIG. 4, i.e. the text which is common to all recipients, is shown below the auxiliary message text 72, in this example. Furthermore, the data recipient field of the e-mails shown in FIG. 4 and FIG. 5 show the recipients of the e-mail in the same way as a standard e-mail. This means that either one of the recipients can use standard functionality such as “reply all”, as if the received e-mail were a standard e-mail. Optionally, data indicating which of the recipients received the text of the auxiliary message 72 may be associated with the text of the auxiliary message.

The e-mail received by the recipient “Recipient 1” will look like a standard received e-mail, and there will be no indication that he is not party to some information received by another recipient. Obviously, in this case the recipient cannot view the content of the auxiliary message.

In the instance when an e-mail without any auxiliary message is sent, preferably the received e-mail looks the same as a standard e-mail to all recipients irrespective of whether or not they have the software upgrade.

In the instance when an e-mail with an auxiliary message is sent to a recipient without the software upgrade, preferably the recipient will receive the main e-mail containing the common data as well as further standard e-mail containing the auxiliary message as an encrypted attachment. This additional e-mail may contain a message within the area showing the message body text 76, such as “You have received an auxiliary message which cannot be viewed”. The message may contain a link enabling the user to download or buy a software upgrade, so that the auxiliary message can be subsequently viewed.

### Implementation Details

A detailed discussion of a system and its operation according to a first embodiment of the present invention will now be described.

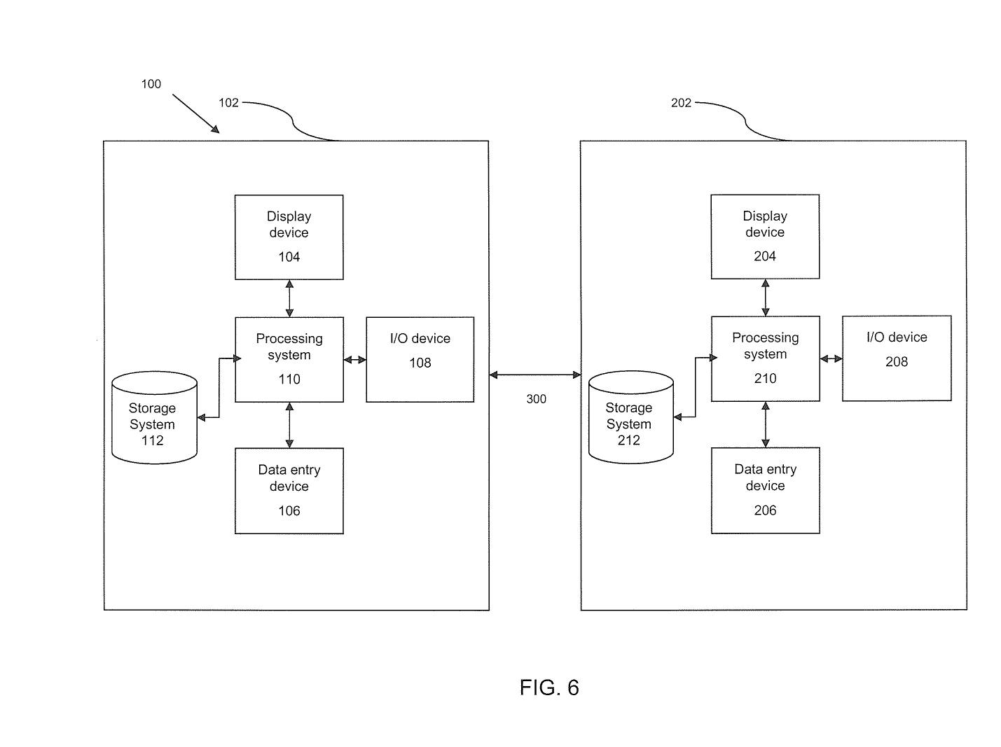

FIG. 6 is a schematic diagram showing a system 100 for implementing embodiments of the present invention. The system 100 comprises a first apparatus 102, and a second apparatus 202. The first apparatus comprises a display device 104, a data entry device 106, an input/output unit 108, a processing system 110 and a storage system 112. The first apparatus 102 may be configured as a client terminal, or sever, for example. Similarly, the second apparatus 202 comprises a display device 204, a data entry device 206, an input/output unit 208, a processing system 210 and a storage system 212. The second apparatus 202 may also be configured as a client terminal, or server, for example. The first and second apparatus 102, 202 can communicate over a network 300, such as the Internet, as shown schematically in FIG. 6. Further, the first and second apparatus 102, 202 may be connected via a third-party server, such as an authentication server (not shown in FIG. 6). In this case, instead of, or in addition to the messages being split up locally, the messages described below may be sent via authentication server, where they may be split up and/or encrypted. Alternatively, the authentication server may merely be queried with data relating to a sender or recipient. The authentication server may then determine whether the sender or recipient is a subscriber, or licensee of the software enhancement according to embodiments of the present invention, and output a signal accordingly. Further, an encryption key, such as an encryption key discussed below may be transmitted from the authentication server to the first or second apparatus.

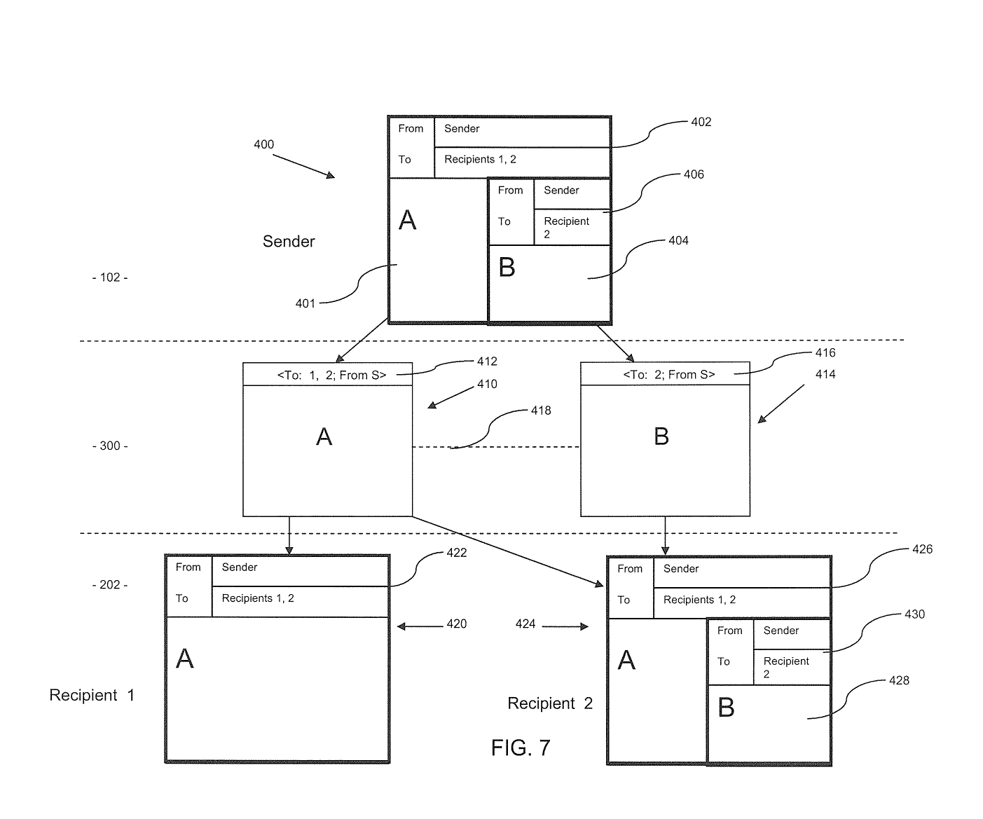

The operation of a system such as the one shown in FIG. 6 will now be described with reference to FIG. 7. FIG. 7 is a schematic diagram showing how a message is processed according to embodiments of the present invention. As shown in FIG. 7, a sender creates a multi-part message 400, shown on a display device 104 of the first apparatus, for example. The multi-part message 400 includes a main message 401 and an auxiliary message 404. The multi-part message has a recipient field 402, including identifiers of recipients of the message, shown as “1, 2”, and optionally a sender field having an identifier of the sender, “S”. The main message 401 has a content A. Further, the auxiliary message 404, has a recipient field 406 including identifiers of recipients of the auxiliary message 404, and a content B. As shown in FIG. 7 the multi-part message 400 is intended for recipients 1 and 2, and the auxiliary message 404 is only intended for recipient 1.

When the user wishes to send the multi-part message 400, it is effectively split into two messages: i.e. data is generated indicative of a first message 410 having a header 412 and a content A; and a second message 414 having a header 416 and a content B. These messages are transmitted over the network 300 as data. As can be seen from FIG. 7, the header of the first message 412 shows that this message is from the sender S, and is destined for recipient 1 and recipient 2, whereas the header of the second message 416 is from the sender S, but only destined for recipient 2. The step of splitting the multi-part message 400 into a first 410 and second 414 message may be performed by the processing system 110 of the first apparatus 102 shown in FIG. 6, for example.

Further, association data 418, for associating the first message 410 to the second message 414 is created. The association data 418 may be created when the multi-part message is split up into the first 410 and second messages 414, or the association data may be created when the multi-part message is created or edited. Alternatively, the association data 418 may be generated after the first 410 and second 414 messages have been transmitted, and transmitted separately from the first 410 and second 414 messages. The association data 418 is shown schematically as a dotted line between the first message 410 and the second message 414 in FIG. 7. The association data 418 may be part of the first message 410 and/or the second message 414; for example, the association data 418 may be part of the header of one or more of the messages. Further, the association data 418 may be an encryption key or part of an encryption key.

Further, in the case where some or all of the association data 418 is present in one of the messages, the association data 418 may contain “message counter” information about how many messages are associated, and data relating to a hierarchy of the messages. For example, the first message 410 is representative of the content of the multi-part message 400 which is intended for all of the recipients. Therefore, any association data 418 present in the first message 410 may indicate that this message is the first message of two. Similarly, the second message 414 is representative of the content of the auxiliary message 404, which is only intended to go to recipient 2, and is intended to be kept secret from recipient 1. Any association data 418 present in the second message 414 may indicate that this is the second message of two. In the case where the association data 418 is an encryption key, a message counter (i.e. such data relating to the hierarchy of the messages) may be included in the encryption key. A detailed discussion of the encryption technique is given below.

Alternatively, the association data 418 may comprise a further message (not shown), sent separately from the first message 410 and the second message 414.

As can be seen schematically in FIG. 7 the first 410 and second 414 messages are then transmitted (for example, across the network 300 shown in FIG. 6), together with the association data 418. The interfaces between the first apparatus 102 and the network 300; and the network 300 and the second apparatus 202 are shown in FIG. 7.

The messages 410, 414 are received for example, by the second apparatus 202 shown in FIG. 6, which is a server, or a user terminal associated with one or more of the recipients. Further, the association data 416 is received. The association data may be received or accessed together with the first 410 and second 414 messages. Alternatively, the association data may be received or accessed subsequently to the first 410 and second 414 messages. As a further alternative, the association may be received, or accessed prior to receiving the first 410 and second 414 messages. The association data 416 is processed, and used to associate the first 410 and second 414 messages with each other so that they can be displayed in association with each other. The first and second messages 410, 414 are then dynamically re-combined according to the output of the processing of the association data, for each recipient. Thus, the first 410 and second 414 messages can be displayed on the display device 204 of the second apparatus 202 (if the recipients' system 202 has the software upgrade successfully installed). Alternatively, such as in the case of a server operating a webmail service, for example, the second message is prepared for display in association with the first message, or a signal for displaying the first 410 and second 414 messages in association can be output, so that the messages can be displayed in association with each other on a display device operated by a third party. Recipient 1 is only privy to message content A. Therefore, the processing system 210 of the second apparatus 202 receives the first message 410 addressed to recipient 1, but does not associate the second message 414, since it is not addressed to recipient 1. Therefore, a message 420 received by recipient 1 corresponds to the first message 410, and has a recipient field 422. Recipient 2 is privy to message content A and message content B. Therefore the processing system 210 receives the first message 410 and the second message 414 and associates the first message 410, having content A with the second message 414, having content B, using the association data 418, to form a message 424 received by recipient 2. The processing system 210 can then arrange for the message 424 to be displayed in association with each other on the display device 204. This message 424 has a recipient field 426. Thus, recipient 2 can view both content A and content B. The message content B can be shown as a separate portion 428 of the received message 424, and an indication of the recipients of the message content B may be given (this is shown in a recipient field 430 in FIG. 7). Alternatively, the message content B can be displayed on a GUI associated with message content A, or message content B may be accessible via a link associated message content A, or the received message 424 may contain some other indicator of the existence of content B. The process of re-combination of the messages is described in more detail below with reference to the encryption process.

Thus, the invention provides a method and system which can send two or more linked messages in response to receiving data indicative of a single user input, such as the user clicking a “Send” button only once; the “Send” button may be such as that shown in FIG. 1. The linked messages are not sent until each of the messages are composed by the user.

Further, the invention provides a method and system which can receive two or more linked messages. The received messages are not displayed to the user until each of the messages have been received, and associated using the association data.

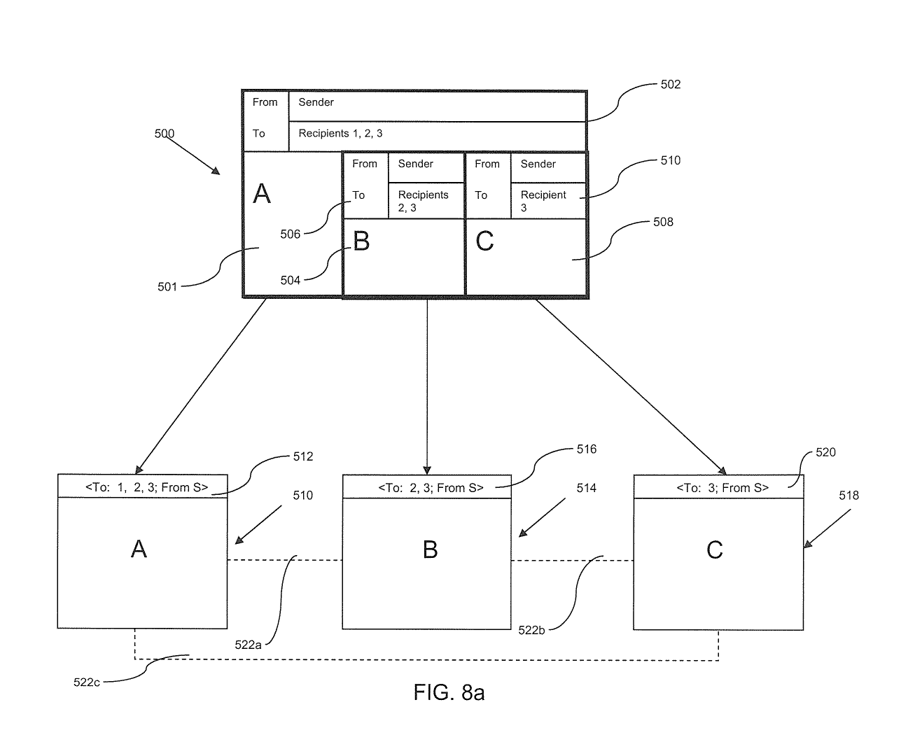

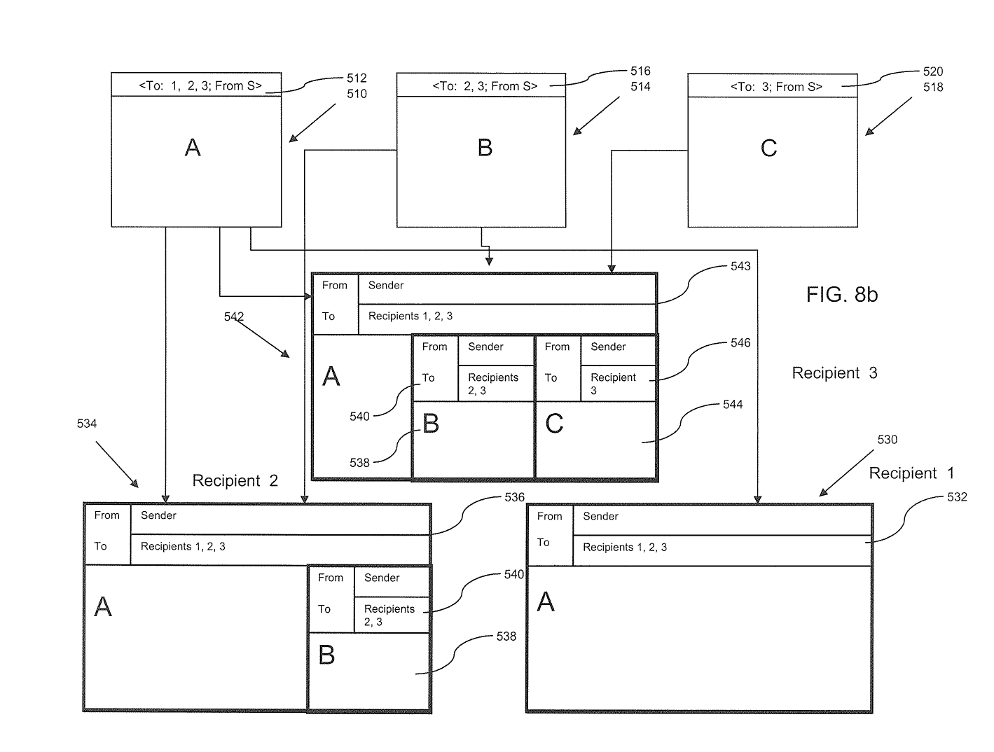

FIGS. 8a and 8b are schematic diagrams showing the processing of a multi-part message 500 from a sender S to three recipients, recipients 1, 2 and 3. FIG. 8a shows a multi-part message 500; this is shown as a representation of how it could appear on a display device, such as the display device 104 of the first apparatus 102. In the case where the auxiliary message is displayed as a GUI the message would appear as a normal message, and a GUI having the content of the auxiliary message would appear when appropriate input from the user is received. Alternatively, a single message interface could switch between showing the content B and C. The multi-part message 500 comprises a main message 501 having message content A. The main message 510 has a recipient field 502, showing identifiers of recipients 1, 2 and 3. In this example, the multi-part message 500 further comprises a first auxiliary message 504, containing content B having a recipient field 506, and being destined for recipients 2 and 3; and a second auxiliary message 508, containing content C having a recipient field 510 and being destined for recipient 3 only.

As above, the multi-part message 500 is split up. In this example, the multi-part message is split into a first message 510 having a header 512, a second message 514, having a header 516, and a third message 518, having a header 520. Further, association data 522a, 522b, 522c is generated, before the messages are transmitted. Again, this is shown in FIG. 8 as dotted lines, linking the first 510 and second 514 messages; the second 514 and third 518 messages, and the first 510 and third 518 messages, since each of these has a common recipient, namely recipient 3. The first, second and third messages are transmitted across the network 300. Further, the association data 522a, 522b and 522c is transmitted (this may be together with one or more of the first, second or third messages, or separately therefrom). The first message 510 is destined for recipients 1, 2 and 3, and has message content A; the second message is destined for recipients 2 and 3, and has message content B; the third message is destined for recipient 3 only, and has message content C. In the alternative case where the first auxiliary message 504 (having message content B) is intended to be received by recipient 2 only, the second 514 and third messages 518 need not be associated with each other, provided that both are associated with the first message 510.

FIG. 8b shows the first 510, second 514 and third 518 messages being received, and dynamically matched, according to the recipient of each (for clarity the association data is not shown in FIG. 8b). The processing system 210 of the second apparatus 202 for each recipient receives the messages intended for that recipient, receives or accesses the association data and associates the messages using the association data. The messages received by each recipient, as shown on a display device, such as the display device 204 of the second apparatus 202 are shown in FIG. 8b (for clarity the interface between the apparatus 102, 202 and the network 300 are not shown in FIGS. 8a and 8b. A message 530 received by recipient 1 (having a recipient field 532) contains only content A, a message 534 (having a recipient field 536) received by recipient 2 contains content A and content B (content B begin shown in an auxiliary message 538 having a recipient field 540), and a message 542 received by recipient 3 (having a recipient field 543) has content A, content B and content C (contents B and C are show in respective auxiliary messages 538, 544, which may have recipient fields 540, 546, respectively, to show the recipients thereof). As above, the recipient field of each of the received messages, and each of the received auxiliary messages, may show the recipients of each. Therefore, any or each of the users may determine which of the other recipients have received the message, and can reply to the other recipients of the message. Again, the process of dynamically recombining the messages will be described in more detail below.

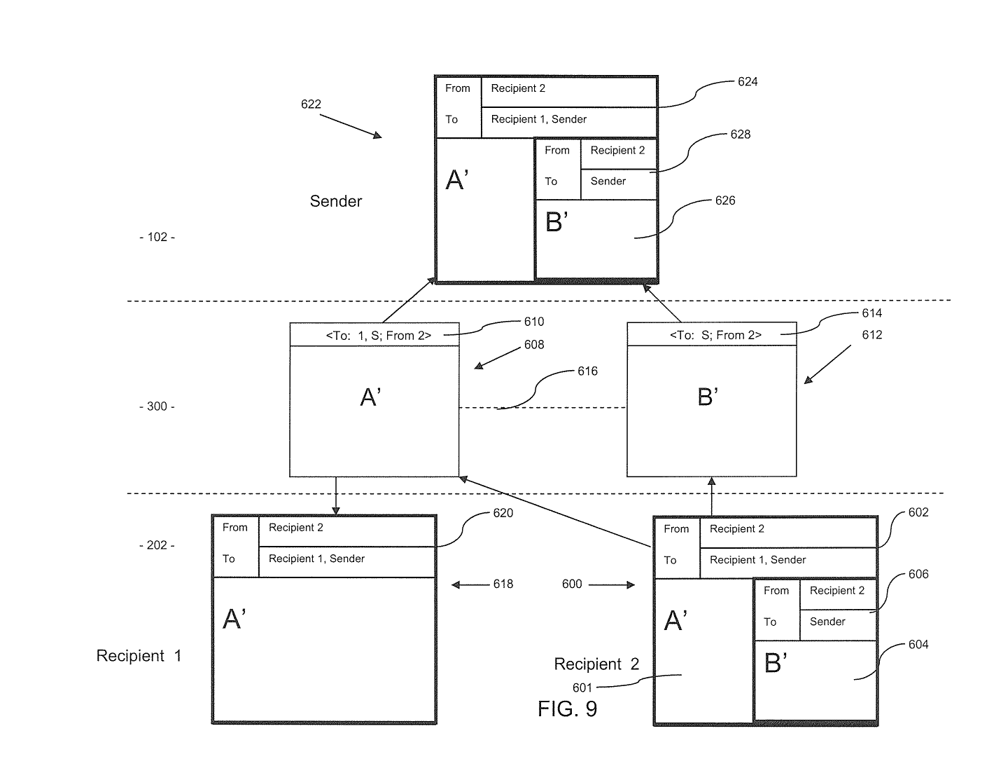

A discussion of the process of replying to a message containing an auxiliary message will now be described with reference to FIG. 9. FIG. 9 shows the processing of a reply sent by recipient 2 of FIG. 7. In this example recipient 2 wishes to reply to the message 424 he has received (as described with reference to FIG. 7). In this case, recipient 2 inputs data to the second apparatus 202 (for example, via data entry device 206) indicative of the fact that he wishes to reply. A multi-part reply message 600 is created. The multi-part reply message comprises a main reply message 601, having a recipient field 602, the contents of which are indicative of the fact that the main reply message 601 is being sent to recipient 1 and to the original sender S. The multi-part reply message 600 further comprises an auxiliary message 604, having a recipient field 606. The content of the multi-part message 600 is updated by the user, for example; this updated content is shown as content A′. Further, the content of the auxiliary message 604 is updated (shown as content B′). The recipient field 606 of the auxiliary message 604 reflects the fact that the content of this message is only intended for the original recipient, and that it is not intended for recipient 1 (since recipient 1 was not privy to the original text A). A′ may contain content A, together with additional content or content A′ may be different from content A. Similarly, B′ may contain content B, together with additional content or content B′ may be different from content B.

Alternative mechanisms for replying to messages, such as those received in FIG. 7 will now be described. If a recipient of an auxiliary message 428 wants to either reply, reply-to-all, or forward the main message without inclusion of any of the content of the auxiliary message, then they would provide the appropriate input to the standard interface of the received message 428. The new message would give the option to create a new auxiliary message associated with it as if it were a new message.

Alternatively, in the case where the message interface includes a floating GUI, if the recipient of an auxiliary message 428 wants to either reply, reply-to-all, or forward the main message with inclusion of an auxiliary message returning to the sender S only, they would provide the appropriate input on the floating GUI. They would have the further option of (reply, reply-to-all, or forward) “ . . . as message” or (reply, reply-to-all, or forward) “ . . . as auxiliary message”. In the case of choosing “as message” (using the example reply-to-all “as message”) text B′ of the auxiliary message 428 would be inserted into the message body field of the new message and all recipient identifiers present in the received message 424 in the received c-mail distribution list will be inserted into the new e-mail distribution fields. In the case of choosing “as auxiliary message” (using the example of reply-to-all “as auxiliary message”) text B would be inserted into the content of the new auxiliary message and an identifier of the originator would be inserted into its respective “To” field.

Turning back to FIG. 9, the multi-part message 600 is processed in a similar way to the messages discussed above. The multi-part message 600 is split into a fourth message 608, having a header 610, and a fifth message 612, having a header 614. The fourth message 608 has content A′, and the data in the header 610 is representative of the fact that the content is destined for recipient 1 and the original sender S. The fifth message 612 contains content B′, and the contents of the header 614 reflect the fact that the content is destined for the original sender S only. Further, association data 616 is generated. The fourth 608 and fifth 612 messages are received and combined in the way described above, so that a message 618, having a recipient field 620 received by recipient 1, contains only content A′. The message 622 received by original sender S, has a recipient field 624, and contains content A′ and B′. The content B′ is displayed in an auxiliary message 626 having a recipient field 628. Again, the integrity of the recipient fields of the received messages are intact.

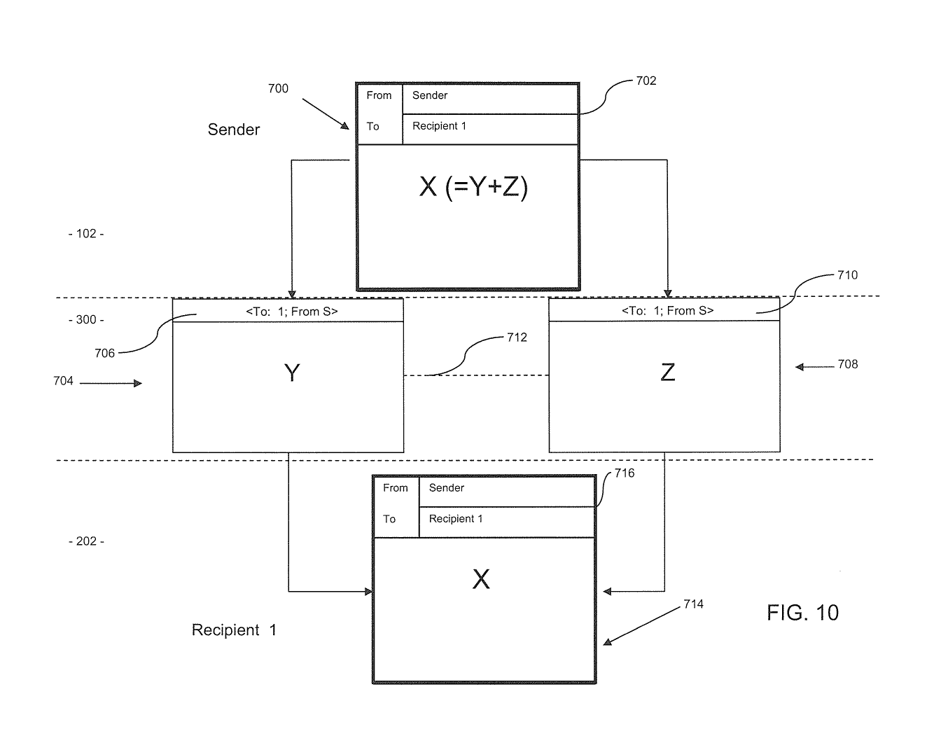

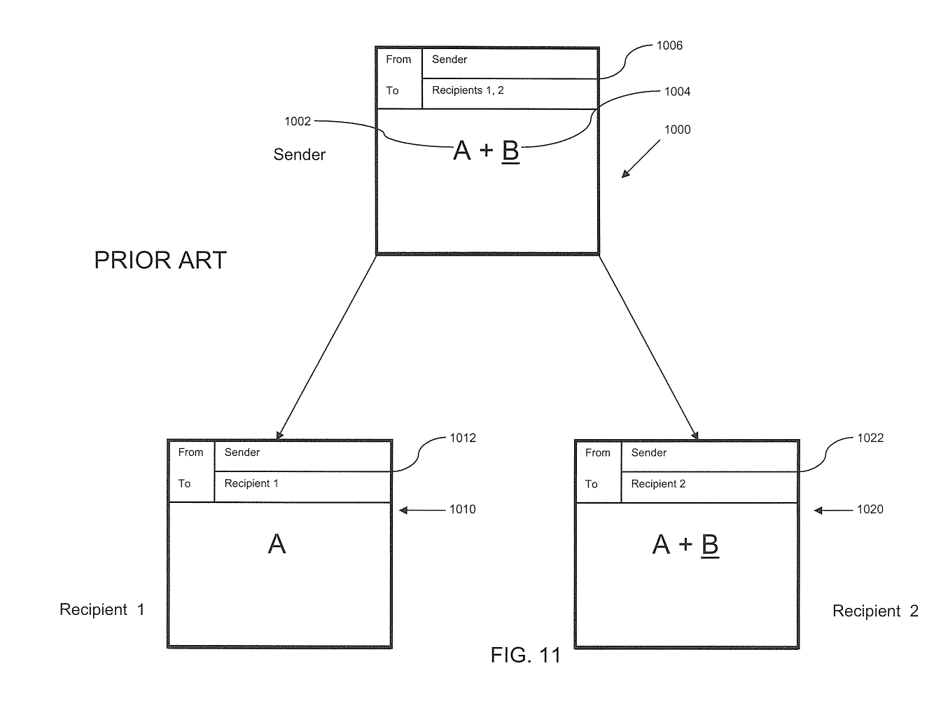

A second embodiment of the present invention will now be described with reference to FIG. 10. FIG. 10 is a schematic diagram showing a message 700 to be sent from a sender to a first recipient. A multi-part message 700 having a content X (in which X comprises content Y and Z) is created by a sender inputting data onto the first apparatus 102, for example, via the data entry device 106. The multi-part message has a recipient field 702, containing an identifier of a first recipient. When the sender wishes to send the message 700, the message is split up into a primary 704 message having a header 706, and a secondary message 708 having a header. The headers 706, 710 of the primary 704 and secondary 708 messages correspond to the recipient field 702 of the multi-part message 700, i.e. indicative of the fact that the message is destined for the first recipient.

The primary message 704 has the content Y, and the secondary message 708 has the content Z. The respective contents Y and Z may each represent half of the content X, by splitting text in the content X into different sections of text. Alternatively, the respective contents Y and Z may each represent abstract portions of the content X, so that none of the content X could be deciphered by viewing either Y or Z.

Association data 712, associating the primary 704 and secondary 708 messages is created. The association data 712 may comprise any of the data discussed above in relation to the first embodiment. In a similar way to that discussed above, the messages 704, 708 are encrypted, and transmitted. Further, the association data 712 is transmitted. The messages 704, 708 are then received by the second apparatus 202, and dynamically recombined for recipient 1, using the association data 712, which is also received, or otherwise accessed. In this way the content X is recovered from matching content Y to content Z. Thus, recipient 1 receives a message 714, having a recipient field 716. This message corresponds to the multi-part message 700 created by the sender.

Prior to sending a message in this manner, the sender's software will check with a 3^{rd} party server to verify that the recipient has a software upgrade, according to embodiments of the present invention. If the recipient does, the message will be encrypted in the above mentioned manner automatically. If the recipient does not have the software upgrade, the message will not be encrypted in this manner and sent as a traditional, single part message.

It will be apparent to the skilled reader that the teaching of the first embodiment and the second embodiment can be combined. Thus, a system in which auxiliary messages destined to only certain recipients can be realised, and where the content of the auxiliary messages is split, in to two messages, and recombined. For example the multi-part message shown in FIG. 10 may represent the auxiliary message shown in FIG. 7.

### Encryption

A detailed discussion of an example of the encryption keys used in the first and second embodiments of the present invention will now be described with reference to FIGS. 7 and 8. In the foregoing, reference is made to first, second and third messages, from the first embodiment. It will be apparent that the encryption methods apply equally to the second embodiment, or to a combination of the first and second embodiments. In this case it will be apparent that references to first and second messages should be replaced with references to primary and secondary messages.

For example, an authentication encryption key (AEK) may be created, and turned into an auxiliary message encryption key (SEK) having a first portion and a second portion (SEKp1, SEKp2). SEKp1 is then inserted into the header of the first message, and SEKp2 is inserted into the header of the second message. SEKp2 may include the data relating to the recipient of the second message, or alternatively, may be associated with data relating to the recipient of the second message. Further, the encryption key may be generated on a per-message basis, or may be generated on a temporal basis. For example, a different encryption key can be used each day. In this case, SEKp1 and/or SEKp2 may be associated with temporal information, such as the time and date (shown as “xyz” below). Further, data such as words or characters contained in the subject line can be associated with the encryption key.

A specific example of the encryption keys AEK and SEK will now be given. In this example the SEK is made from the AEK and a message counter. For example, SEK may comprise the following: 2BZ76AF3DDFC7FFED31B0C9B8FAA6150F914QRT90LD978FAE8B112490A1E23424943C2C

This key is then split into two portions, SEKp1 and SEKp2, as follows:

SEKp1: 2BZ76AF3DDFC7FFED31B0C9B8FAA6150F91

SEKp2: 4QRT90LD978FAE8B112490A1E23424943C2C

The first message is then sent out with SEKp1, and the second message is sent out with: ((SEKp2+recipient 2) encrypted with SEKp1) e.g. ((4QRT90LD978FAE8B112490A1E23424943C2C”Recipient1”xyz) encrypt with 2BZ76AF3DDFC7FFED31B0C9B8FAA6150F91).

This provides a relatively simple method of encrypting an auxiliary message.

A processing system 210 associated with Recipient 1 receives the first message (which is intended for him). The first message has not been encrypted, so the processing system 210 can display the message on the display device 204, so that recipient 1 can read the content A. However, if the second message (which is not intended for the first recipient) is also received, recipient 1 will not be able to read it; the second message has been encrypted, and the key from the first message will not work to decrypt the second message, since the identifier of this recipient is not present in SEKp2. Therefore recipient 1 cannot access the content B.

A processing system 210 associated with Recipient 2 receives the first message, and the second message (both of which are intended for the recipient). In this case the first and second messages are matched by the processing system 210 on the basis of the association data. For example, the processing system 210 can match the identifier contained in the encryption key SEKp2 with the identifier of recipient 2. Then SEKp1 from the first message is used to decrypt SEKp2 in the second message. Accordingly, recipient 2 can read both message content A, and content B.

It will be apparent to those skilled in the art that in order to decrypt message 2 it is necessary to have the first portion of the encryption key from the first message, and the second portion of the key from the second message. Further the network identifier of a recipient must match that contained in the second portion of the encryption key, in order for that recipient to view the second message content B.

Preferably, the message received by recipient 1 will appear to be a standard message, so that there is no way recipient 1 can tell that the message has been combined with other information for other recipients. In this way the privacy of the existence of the restricted information is maintained. Even if the SEK were found to be in the header, the presence of such data would not necessarily mean that an auxiliary message had been sent with the main message, since this data would merely indicate that the message had been split up. This splitting up could be in conjunction with the encryption technique discussed in the second embodiment of the present invention, for example, and would not be indicative of restricted content.

Further, the recipient field will not give recipient 1 any indication that the message has been combined with other information for other recipients, since the recipient field contains an identifier of recipient 2.

This has the further advantage that recipient 1 can “reply all”, so that a reply is sent to all of the relevant parties.

The message received by recipient 2, and displayed by the processing system 210 will contain both the content A, and the content B, since recipient 2 is authorised to view content B. The content A and content B may be shown in a variety of ways. For example, a composite message can be displayed to recipient 2, so that the message content B is shown in an auxiliary message. Alternatively, the message content B may be displayed in a pop-up window. In the latter case the software may cause the second apparatus 202 shown in FIG. 6 to intercept the first and second message, together with the association data. Recipient 2 would then be presented with content A, shown as a normal message, via display device 204, and message content B is stored separately. In this case the association data can be used to show message content B as a pop-up window, when recipient 1 either opens the message or holds a mouse pointer over the first message, displayed on a display device.

Turning again to FIG. 8, an example of how the messages are encrypted when there is more than one auxiliary message will now be described. Using the example above, where SEK comprises the following: 2BZ76AF3DDFC7FFED31B0C9B8FAA6150F914QRT90LD978FAE8B112490A1E23424943C2C

This key is again split into two portions, SEKp1 and SEKp2, as follows:

SEKp1: 2BZ76AF3DDFC7FFED31B0C9B8FAA6150F91

SEKp2: 4QRT90LD978FAE8B112490A1E23424943C2C

In this case, the first message is sent out with SEKp1, and the second message is sent out with: ((SEKp2+recipient 2; recipient 3) encrypted with SEKp1). The third message is sent out with ((SEKp2+recipient 3) encrypted with SEKp1). As above, each of the messages may contain data relating to the hierarchy of the messages. For example, the first message may contain data indicative of the fact that it is the first message of 3; the second message may contain data indicative of the fact that it is the second message of 3, and the third message may contain data indicative of the fact that it is the third message of 3. When each message is received they are assembled into messages for each recipient accordingly. For example, the first message is received, and the processing system realises from the message counter data that it is the first message, and to look for the other messages. The second message is received, and the processing system realises from the message counter data that it is the second message. The association data may contain further identifiers to enable the processing system to combine the messages. When the second message is received the identifier included in the encryption key is used, with the identifiers of recipients 2 and 3 to assign the content of the second message to recipients 2 and 3. The portion of the encryption key from the first message is used to decrypt the message content of the second message for these recipients, and to combine the message content of the second message with that of the first for recipients 2 and 3.

When the third message is received, the identifier included in the encryption key is used, with the identifier of recipient 3 to assign the content of the third message to recipient 3. Using the association data, the first message is matched to the third message, and the first portion of the encryption key is used to decrypt the encryption key in the third message for recipient 3. The content C of the third message is then married with the content B of the second message and the content A of the first message, and displayed to recipient 3.

The software enhancement according to embodiments of the present invention may comprise an application, which runs on a processing system, such as the processing system 210 of the second apparatus, which identifies association data in received messages. Thus, the application associates received messages, such as a message and one or more auxiliary messages, so that they can be displayed in association with each other.

It will be apparent to those skilled in the art that the messages discussed above may be encrypted, or further encrypted with known encryption methods. However, a discussion of this has been omitted above for clarity.

Further, it will be appreciated that the messages discussed above may comprise e-mail messages, or other alphanumeric messages.

The above embodiments are to be understood as illustrative examples of the invention. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of processing multi-part messages which are received over a data communications network, comprising, for a multi-part message, processing multiple messages each comprising header data and non-header content and originating from a sender and being destined for at least a first auxiliary message recipient, the method comprising the steps of:
receiving a main message, said main message comprising header data indicative of a first set of recipients for said main message, said first set of recipients comprising at least a main message recipient and said first auxiliary message recipient;
receiving a first auxiliary message, said first auxiliary message comprising header data indicative of a second set of recipients for said first auxiliary message, said second set comprising at least said first auxiliary message recipient;
receiving first message association data indicative of an association between said main message and said first auxiliary message, said first message association data originating from said sender; and
preparing said first auxiliary message for display on a message interface which includes a main message interface part and a first auxiliary message interface part, wherein said first auxiliary message interface part displays said first auxiliary message as a message auxiliary to said main message, on the basis of said first message association data.

2. A method according to claim 1, wherein said method further comprises the steps of:
receiving a second auxiliary message, said second auxiliary message comprising header data indicative of a third set of recipients for said second auxiliary message, said third set of recipients comprising at least said first auxiliary message recipient, wherein said second set of recipients includes a second auxiliary message recipient and said third set of recipients does not include said second auxiliary message recipient;
receiving second message association data indicative of an association between said main message and said second auxiliary message, said second message association data originating from said sender; and
preparing said second auxiliary message for display on said message interface, said message interface comprising a second auxiliary message interface part, wherein said second auxiliary message interface part displays said second auxiliary message as a message auxiliary to said main message, on the basis of said second message association data.

3. (canceled)

4. A method according to claim 1, wherein said first auxiliary message comprises non-header content which is not in said main message.

5. A method according to claim 1, wherein said main message comprises non-header content which is not in said first auxiliary message.

6. A method according to claim 1, wherein said method further comprises transmitting a multi-part response message replying to said multi-part message originating from said sender, said method comprising the steps of:
receiving response data indicative of response message non-header content from said first auxiliary message recipient, said response message non-header content comprising main reply message non-header content and first auxiliary reply message non-header content,
deriving a first set of reply message recipients to include at least said sender and said main message recipient;
deriving a second set of reply message recipients to include at least said sender;
creating a main reply message, addressed to said first set of reply message recipients, said main reply message comprising said main reply message non-header content;
creating a first auxiliary reply message, addressed to said second set of reply message recipients, said first auxiliary reply message comprising said auxiliary reply message non-header content; and
creating reply message association data, said reply message association data associating said main reply message with said first auxiliary reply message.

7. A method according to claim 6, wherein said deriving steps comprise deriving said reply message recipients from header data, indicative of said sender and indicative of at least said main message recipient, in said multi-part message originating from said sender.

8. A method according to claim 7, wherein said deriving steps comprise deriving in response to initiation of a reply-to function by said first auxiliary message recipient.

9. A method according to claim 6, wherein said main reply message non-header content comprises non-header content derived from said main message, and said auxiliary reply message non-header content comprises non-header content derived from said first auxiliary message.

10. A method of creating multi-part messages which are for transmission over a data communications network, comprising, for a multi-part message, creating multiple messages each comprising header data and non-header content and originating from a sender and being destined for at least a first auxiliary message recipient, the method comprising the steps of:
accessing data indicative of multi-part message non-header content, said multi-part message non-header content comprising main message non-header content and first auxiliary message non-header content;
accessing data indicative of a first set of recipients for said main message non-header content, said first set of recipients comprising at least a main message recipient and said first auxiliary message recipient;
creating a main message, addressed to said first set of recipients, said main message comprising said main message non-header content;
accessing data indicative of a second set of recipients for said first auxiliary message non-header content, said second set of recipients comprising at least said first auxiliary message recipient;
creating a first auxiliary message, to said second set of recipients, said first auxiliary message comprising said auxiliary message non-header content; and
creating association data, said association data associating said main message with said first auxiliary message.

11. A method according to claim 10, wherein said multi-part message content further comprises second auxiliary message non-header content, said main message non-header content not comprising said second auxiliary message non-header content, and wherein said method further comprises the steps of:
accessing data indicative of a third set of recipients for said second auxiliary message non-header content, said third set of recipients comprising at least a second auxiliary message recipient;
creating a second auxiliary message, addressed to said third set of recipients, said second auxiliary message comprising said second auxiliary message content; and
creating association data, said association data associating said main message with said second auxiliary message.

12. (canceled)

13. A method according to claim 10, wherein said association data is adapted for associating said main message with said first auxiliary message using a function specific to said multi-part messages.

14. A method according to claim 10, wherein said association data comprises a first portion of association data, and a second portion of association data, and wherein said main message comprises said first portion of association data, and said first auxiliary message comprises said second portion of association data.

15. A method according to claim 14, wherein said first portion of association data comprises a first portion of an encryption key, and wherein said second portion of association data comprises a second portion of an encryption key.

16-44. (canceled)

45. A method according to claim 1, wherein said second set of recipients does not include said main message recipient.

46. A method according to claim 4, wherein said first auxiliary message comprises non-header content which is encrypted and includes a link to enable a recipient to access a software upgrade, whereby the encrypted non-header content of the first auxiliary message can be subsequently viewed in unencrypted form.

47. A method according to claim 1, wherein said association data is adapted for associating said main message with said first auxiliary message using a function specific to said multi-part messages.

48. A method according to claim 1, wherein said association data comprises a first portion of association data, and a second portion of association data, and wherein said main message comprises said first portion of association data, and said first auxiliary message comprises said second portion of association data.

49. A method according to claim 48, wherein said first portion of association data comprises a first portion of an encryption key, and wherein said second portion of association data comprises a second portion of an encryption key.

50. A method according to claim 48, wherein said association data is located in said header data of said main message and said first auxiliary message.

51. A method according to claim 1, wherein said main message is a first e-mail message and said first auxiliary message is a second e-mail message.

52. A method according to claim 10, wherein said second set of recipients does not include said main message recipient.

53. A method according to claim 10, wherein said main message does not include said first auxiliary message non-header content.

54. A method according to claim 10, wherein said first auxiliary message does not include said main message non-header content.

55. A method according to claim 14, wherein said association data is located in said header data of said main message and in the header data of said first auxiliary message.

56. A method according to claim 10, wherein said main message is a first e-mail message and said first auxiliary message is a second e-mail message.

57. A computer-readable storage medium storing program code for causing a computer to process multi-part messages which are received over a data communications network, said processing comprising, for a multi-part message, processing multiple messages each comprising header data and non-header content and originating from a sender and being destined for at least a first auxiliary message recipient, the program code being for causing a computer to perform the steps of:
receiving a main message, said main message comprising header data indicative of a first set of recipients for said main message, said first set of recipients comprising at least a main message recipient and said first auxiliary message recipient;
receiving a first auxiliary message, said first auxiliary message comprising header data indicative of a second set of recipients for said first auxiliary message, said second set comprising at least said first auxiliary message recipient;
receiving first message association data indicative of an association between said main message and said first auxiliary message, said first message association data originating from said sender; and
preparing said first auxiliary message for display on a message interface which includes a main message interface part and a first auxiliary message interface part, wherein said first auxiliary message interface part displays said first auxiliary message as a message auxiliary to said main message, on the basis of said first message association data.

58. A computer-readable storage medium storing program code for causing a computer to create multi-part messages which are for transmission over a data communications network, said creating comprising, for a multi-part message, creating multiple messages each comprising header data and non-header content and originating from a sender and being destined for at least a first auxiliary message recipient, the program code being for causing a computer to perform the steps of:
accessing data indicative of multi-part message non-header content, said multi-part message non-header content comprising main message non-header content and first auxiliary message non-header content;
accessing data indicative of a first set of recipients for said main message non-header content, said first set of recipients comprising at least a main message recipient and said first auxiliary message recipient;
creating a main message, addressed to said first set of recipients, said main message comprising said main message non-header content;
accessing data indicative of a second set of recipients for said first auxiliary message non-header content, said second set of recipients comprising at least said first auxiliary message recipient;
creating a first auxiliary message, to said second set of recipients, said first auxiliary message comprising said auxiliary message non-header content; and
creating association data, said association data associating said main message with said first auxiliary message.
